(19) United States
(12) Patent Application Publication
(10) Pub. No.: US 2006/0246393 A1
(43) Pub. Date: Nov. 2, 2006

(54) Device and method of operation by means of a hand-held dental instrument

(76) Inventors: Wolfgang Eiff, Heppenheim (DE); Peter Fornoff, Reichelsheim (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/410,899

(22) Filed: Apr. 26, 2006

(30) Foreign Application Priority Data
Apr. 28, 2005 (DE) 10 2005 020 240.3

(51) Int. Cl. A61C 1/02

(52) U.S. Cl. 433/98

(57) ABSTRACT

A device for operation by means of a hand-held dental instrument, in which a function of the instrument is triggered by a user by means of a triggering device, in which the device comprises a delay circuit which causes a time delay between triggering and activation of the function. In a method of operating a hand-held dental instrument, in which a function of the instrument is triggered by a user by means of a triggering device, triggering actuates a delay circuit which activates the desired function following a time delay.

### TECHNICAL FIELD

The invention relates to a device, which is operated by means of a hand-held dental instrument and to a method of activating a function of the instrument, which function is activated by the operator via a triggering device.

### DESCRIPTION OF THE RELATED ART

A hand-held dental instrument for three-dimensional acquisition of surface structures, which starts a 3D scan upon triggering, is disclosed in DE 198 29 278 C1.

When using the instrument disclosed in said patent, the scan and all of the other functions executed with other known hand-held dental instruments must be activated by the operator. Activation can be done either by any existing means on the instrument or via a footswitch, if provided. If activation is effected via the instrument itself, the force exerted thereon will often cause a degree of unsteadiness which will lead to inaccuracies in the function being carried out, for example an intraoral three-dimensional scan. If a footswitch has to be actuated, this will necessarily cause the operator's attention to be distracted momentarily from the act of positioning the instrument, which might lead to unintentional erroneous positioning of the instrument.

Thus the problem to be solved is to ensure that unsteadiness caused by the activation of a function when using a hand-held dental instrument will not lead to faulty execution of the function.

### SUMMARY AND OBJECTS OF THE INVENTION

According to the invention, the device operated by means of a hand-held dental instrument contains a function that is triggered by the operator via a triggering device, and a delay circuit which will cause a time delay between triggering and activation of the function.

This has the advantage that the operator of the instrument will have another opportunity to position the instrument correctly after triggering the function and prior to activation thereof.

The time delay may advantageously be set to a time interval of from 0.5 to 5 seconds. The operator has the possibility of adjusting the time delay to his own individual needs.

Advantageously, means are provided which indicate the time remaining prior to activation of the function. This facilitates estimation of the time left before the function will be activated.

It is particularly advantageous when the remaining time is indicated by an acoustic signal. This can be achieved by causing a frequency change in, or modifying the pulse rate of, the acoustic signal. The advantage of an acoustic signal is that the operator will discern the signal independently of his line of vision.

It may be advantageous if, alternatively or additionally, the remaining time is represented by an optical signal. An optical representation of the remaining time can be realized with minor effort, e.g. by a set-up of diodes or by a progress bar on a graphic display device.

It is particularly advantageous if the optical signal is in the direct visual field of the operator, as this greatly facilitates discernment of the signal by the operator.

Advantageously, the means used to display the optical signal are attached to the instrument itself. When in use, the instrument is often in the visual field of the operator.

A particularly advantageous setup is realized by combining the device with an intraoral scanning device. Such cameras are basically susceptible to variations in the region to be scanned.

When use is made of an intraoral scanning device, the optical signal is advantageously superimposed in an image reproduction unit. Such an image reproduction unit is used to assist positioning of the scanning device and is thus in the operator's visual field.

The invention further relates to a method of operating a handheld dental instrument, in which a function of the instrument is activated by the operator via a triggering device. Following activation, a delay circuit is actuated, which performs time-delayed activation of the desired function. This has the advantage that triggering and activation of a function can be kept apart.

### BRIEF DESCRIPTION OF THE DRAWINGS

The method according to the invention is explained below with reference to the drawings, in which:

FIG. 1 shows the device of the invention.

### DETAILED DESCRIPTION OF AN EXEMPLARY EMBODIMENT OF THE INVENTION

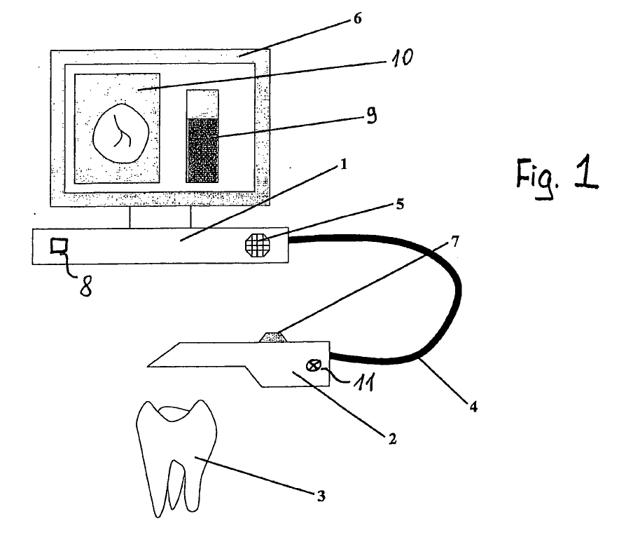

FIG. 1 shows a device 1 of the invention, which is operated by means of a hand-held intraoral scanning device 2 used for scanning a tooth 3. The dental instrument 2 is connected by a cable 4 to the device 1. The device 1 controls a loudspeaker 5 and also a monitor 6 connected to the device 1, which serve to display the time remaining until activation of the function takes place.

When the operator of the intraoral scanning device 2 activates, via the release button 7, a function such as a scan of tooth 3, a signal is transmitted to device 1, which will actuate a delay circuit present 8 in device 1. The time lag can be set by means (not shown) to meet the individual needs of the operator over a range of from 0.5 to 5 seconds.

The remaining time is indicated to the operator by an acoustic signal emitted from the loudspeaker 5 and having a pulse rate which changes with time. Alternatively, the pitch may be varied.

The remaining time is additionally represented on the monitor 6 by means of a progress bar 9, which either decreases with time or increases to a predefined limit. The exact graphical form of the progress bar is of no significance.

In addition, a live image 10 of the region to be scanned by the hand-held intraoral scanning device 2 is displayed on the monitor 6, which enables the operator to keep both the region of the tooth 3 to be scanned and the time left prior to activation of the function within his visual field.

Alternatively, the time remaining till activation may be indicated by an optical signal e.g. by an LED 11 on the hand-held intraoral scanning device 2.

1. A device for operation by means of a handheld dental instrument, in which a function of the instrument is triggered by a user by means of a triggering device wherein the device for operation comprises a delay circuit which causes a time delay between triggering and activation of said function.

2. A device as defined in claim 1, wherein the time delay can be set within a time interval of from between 0.5 and 5 seconds.

3. A device as defined in claim 1, including indicator means to indicate the time remaining until activation of the function.

4. A device as defined in claim 3, wherein said indicator means produce an acoustic signal.

5. A device as defined in claim 3, wherein said indicator means produce an optical signal.

6. A device as defined in claim 5, wherein the optical signal is within the direct visual field of the user.

7. A device as defined in claim 6, wherein the indicator means for producing the optical signal are mounted on the instrument.

8. A device as defined in claim 1, wherein the hand-held dental instrument is an intraoral scanning system.

9. A device as defined in claim 8, including an image reproduction unit in which an optical signal is superimposed.

10. A method of operating a hand-held dental instrument in which a function of the instrument is triggered by a user by means of a triggering device wherein triggering actuates a delay circuit which activates the desired function following a time delay.

11. A device as defined in claim 1, wherein the device for operation is a 3D camera.
